(19) United States
(12) Patent Application Publication
(10) Pub. No.: US 2025/0159091 A1
(43) Pub. Date: May 15, 2025

(54) IMAGE READING DEVICE, IMAGE READING METHOD, AND NON-TRANSITORY RECORDING MEDIUM

(71) Applicant: Kohya Etoh, Kanagawa (JP)

(72) Inventor: Kohya Etoh, Kanagawa (JP)

(73) Assignee: Ricoh Company, Ltd., Tokyo (JP)

(21) Appl. No.: 18/925,266

(22) Filed: Oct. 24, 2024

(30) Foreign Application Priority Data
Nov. 15, 2023 (JP) 2023-194762
Jun. 12, 2024 (JP) 2024-095469

(51) Int. Cl. H04N 1/047; G03G 15/22

(52) U.S. Cl. CPC H04N 1/0473; G03G 15/228; H04N 2201/0081

(57) ABSTRACT

An image reading device including: a motor to reciprocate a carriage, a reference position detector to detect passage and non-passage of the carriage through a reference position and output a detection result, and circuitry configured to, in a case where an abnormality of a stop position of the carriage has been detected based on the detection result, specify a location at which the carriage has abnormally stopped.

### CROSS-REFERENCE TO RELATED APPLICATIONS

This patent application is based on and claims priority pursuant to 35 U.S.C. § 119 (a) to Japanese Patent Application No. 2023-194762, filed on Nov. 15, 2023, and 2024-095469, filed on Jun. 12, 2024, in the Japan Patent Office, the entire disclosure of which is hereby incorporated by reference herein.

### BACKGROUND

### Technical Field

The present disclosure relates to an image reading device, an image reading method, and a non-transitory recording medium.

### Related Art

When an abnormality in the image has been detected at the position of a reference white plate while a carriage of an image reading device is driven, a process of classifying malfunctions of a reader and a traveling body drive system can be performed. When an abnormality of the traveling body drive system of the carriage is newly recognized, the history of errors generated in the reader is corrected. With the classification of the malfunctions of the reader and the traveling body drive system, a component of the traveling body drive system can be changed, and unnecessary replacement of a component can be prevented.

Further, malfunctions of the reader and the traveling body drive system can be classified by analyzing an abnormality of the traveling body drive system after a malfunction of the reader is detected.

### SUMMARY

According to an embodiment of the present disclosure, an image reading device includes a motor to reciprocate a carriage; a reference position detector to detect passage and non-passage of the carriage through a reference position and output a detection result; and circuitry to, in a case where an abnormality of a stop position of the carriage has been detected based on the detection result, specify a location at which the carriage has abnormally stopped.

According to an embodiment of the present disclosure, a method of reading an image by reciprocating a carriage, includes detecting passage and non-passage of the carriage through a reference position to output a detection result, and in a case where an abnormality of a stop position of the carriage has been detected based on the detection result, specifying a location at which the carriage has abnormally stopped.

According to an embodiment of the present disclosure, a non-transitory recording medium stores a plurality of instructions which, when executed by one or more processors, cause the one or more processors to perform a method of reading an image by reciprocating a carriage, including detecting passage and non-passage of the carriage through a reference position to output a detection result, and in a case where an abnormality of a stop position of the carriage has been detected based on the detection result, specifying a location at which the carriage has abnormally stopped.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an image forming apparatus;

FIG. 2 is a diagram illustrating an example configuration of an image reading device;

FIG. 3 is a functional block diagram illustrating example functions relating to an abnormal stop position specification process for a carriage of a control device of an image reader;

FIG. 4 is a flowchart illustrating an example flow of a process of detecting an abnormality in movement of the carriage in the image reading device;

FIG. 5 is a flowchart illustrating an example flow of an operation of adjusting a reference position of the carriage in the image reading device; and

FIG. 6 is a flowchart illustrating an example flow of the abnormal stop position specification process for the carriage in the image reading device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Hereinafter, embodiments of an image reading device, an image reading method, and a program are described in detail referring to the accompanying drawings.

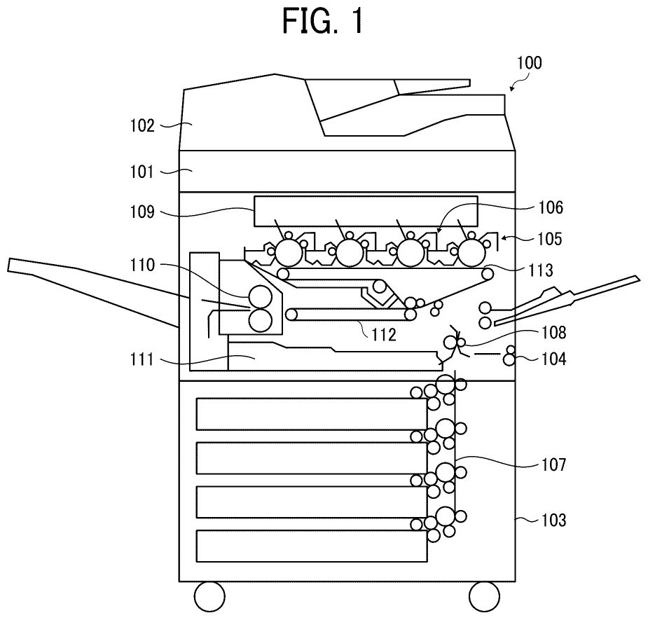

FIG. 1 is a diagram illustrating an example configuration of an image forming apparatus 100. In FIG. 1, the image forming apparatus 100 is generally called a multifunction peripheral (MFP) having at least two of copying, printing, scanning, and facsimile functions.

The image forming apparatus 100 includes an image reader 101 and an automatic document feeder (ADF) 102 that serve as an image reading device, and an image forming device 103 below the image reader 101. In order to describe an internal configuration of the image forming device 103, FIG. 1 illustrates the internal configuration of the image forming device 103 from which an external cover is removed.

The ADF 102 is a document supporter that positions, at a reading position, a document including an image to be read.

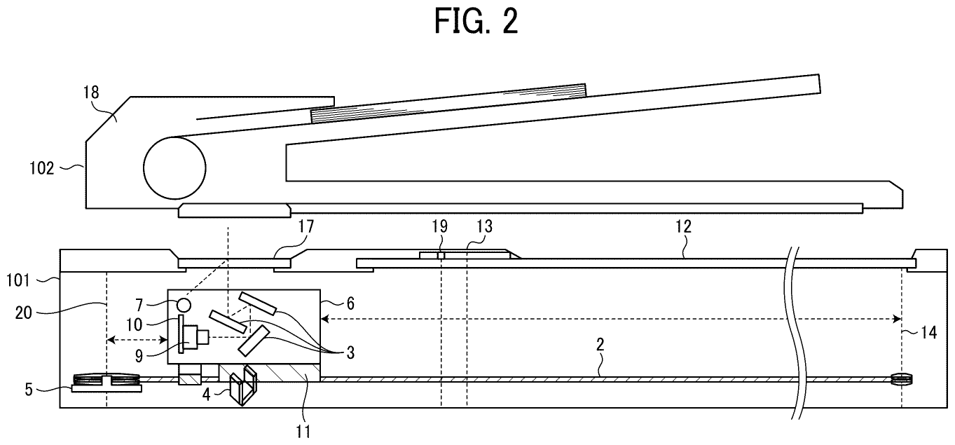

The ADF 102 automatically feeds the document placed on a table to the reading position. The image reader 101 reads the document fed by the ADF 102 at the predetermined reading position. The image reader 101 includes a platen (or an exposure glass) as an upper surface of the image reader 101. The platen serves as a document supporter on which a document is placed. The image reader 101 reads the document on the platen, that is, at the reading position. Specifically, the image reader 101 is a scanner that includes a light source, an optical system, and an image sensor such as a charge-coupled device (CCD) inside. In the image reader 101, the light source emits light to illuminate the document. The light reflected from the document passes through the optical system and reaches the image sensor that reads the light. Thus, the image reader 101 reads an image of the document. That is, the image reader 101 and the ADF 102 are an example of an image reading device that reciprocates a carriage 6 (see FIG. 2) serving as a traveling body and reads an image of a document. The image reading device may have one or more of copying, printing, scanning, and facsimile functions. Accordingly, the image reading device can be applied as a facsimile apparatus or an MFP.

The image forming device 103 prints the image of the document read by the image reader 101. The image forming device 103 includes a manual feed roller pair 104 through which a recording medium is manually inserted and a recording medium supply unit 107 that supplies a recording medium. The recording medium supply unit 107 includes vertically-aligned recording medium supply units 107 and a mechanism that sends out recording media one by one from the recording medium supply units 107. The recording medium thus supplied is sent to a secondary transfer belt 112 via a registration roller pair 108.

A transfer unit transfers a toner image from an intermediate transfer belt 113 onto the recording medium conveyed on the secondary transfer belt 112.

The image forming device 103 also includes an optical writing device 109, an image forming unit 105 (including image forming units 105 for yellow (Y), magenta (M), cyan (C), and black (K)) employing a tandem system, the intermediate transfer belt 113, and the secondary transfer belt 112. In an image forming process, the image forming unit 105 renders a latent image written by the optical writing device 109 visible as a toner image and forms the toner image on the intermediate transfer belt 113.

Specifically, the image forming units (Y, M, C, and K) 105 include four rotatable photoconductor drums (Y, M, C, and K), and each include image forming elements 106 including a charging roller, a developing device, a primary transfer roller, a cleaner unit, and a neutralizer around the corresponding photoconductor drum. The image forming elements 106 function around each of the four photoconductor drums to form a toner image on the corresponding photoconductor drum and transfer the toner image onto the intermediate transfer belt 113. Specifically, the primary transfer rollers transfer the toner images from the respective photoconductor drums onto the intermediate transfer belt 113. As a consequence, a composite toner image is formed on the intermediate transfer belt 113.

The intermediate transfer belt 113 is entrained around a drive roller and a driven roller and disposed so as to pass through primary transfer nips between the four photoconductor drums and the respective primary transfer rollers. As the intermediate transfer belt 113 rotates, the composite toner image primarily transferred onto the intermediate transfer belt 113 is conveyed to a secondary transfer device that secondarily transfers the composite toner image onto a recording medium on the secondary transfer belt 112. As the secondary transfer belt 112 rotates, the recording medium is conveyed to a fixing device 110. The fixing device 110 fixes the composite toner image as a color image onto the recording medium. Finally, the recording medium is ejected onto an output tray disposed outside a housing of the image forming device 103. In the case of duplex printing, a reverse assembly 111 reverses the front and back sides of the recording medium and sends out the reversed recording medium onto the secondary transfer belt 112.

The image forming device 103 is not limited to an electrophotographic image forming device that forms an image by electrophotography as described above. Alternatively, the image forming device 103 may be an inkjet image forming device that forms an image in an inkjet system.

The image reader 101 may be a so-called reduction optical system using a CCD sensor or a so-called contact optical system using a contact image sensor (CIS); however, the image reader 101 is not particularly limited thereto.

As long as the image reading device performs a reading operation, the function to be performed by the image forming apparatus is not particularly limited to a scanning function, and the image forming apparatus may perform a copying function or a facsimile function.

FIG. 2 is a diagram illustrating an example configuration of the image reading device.

The image reader 101 is a scanner device mounted on an image forming apparatus such as a digital copier, a digital MFP, or a facsimile apparatus, or a scanner device that is independently provided. A light source 7 illuminates a document serving as an object with irradiation light. An image sensor board 10 receives light reflected from the document, and generates a signal to obtain image data. Thus, the image reader 101 can read the image data of the document.

As illustrated in FIG. 2, the carriage 6 includes the light source 7 for exposing a document to light, an image sensor 9 that receives light emitted from the light source 7 and reflected from the document and converts the reflected light into a signal, and reflecting mirrors 3 that direct the light emitted from the light source 7 and reflected from the document to the image sensor board 10. Components such as a lens for forming an image and an analog front end (AFE) that converts an analog signal received by the image sensor board 10 into a digital signal are also mounted on the image sensor board 10. The configuration of the carriage 6 is not limited to this example, and the carriage 6 may include a reduction optical system using a CCD sensor or a contact optical system using a CIS. In FIG. 2, the components such as the light source 7, the image sensor 9, and the reflecting mirror 3 are assembled and assembled in the carriage 6. Alternatively, the image sensor board 10 may be attached, and a carriage including the light source 7 and the reflecting mirror may scan. The carriage 6 may be driven with any desired system such as a belt system or a differential mirror system.

As a document is placed on a platen 12, the carriage 6 is reciprocated in a sub-scanning direction (the horizontal direction indicated by the arrow), and an image of the document is read. This process is called flatbed reading. During the flatbed reading, an origin position sensor 4 detects an origin position detection feeler 11 to determine a position serving as a start point at which the carriage 6 is driven; a drive motor 5 rotates to cause the carriage 6 coupled to a drive belt 2 to perform scanning; a reference white plate 13 that is used for correcting variations due to a reading optical system and the document placed on the platen 12 are read; and the carriage 6 returns to the position serving as the start point again.

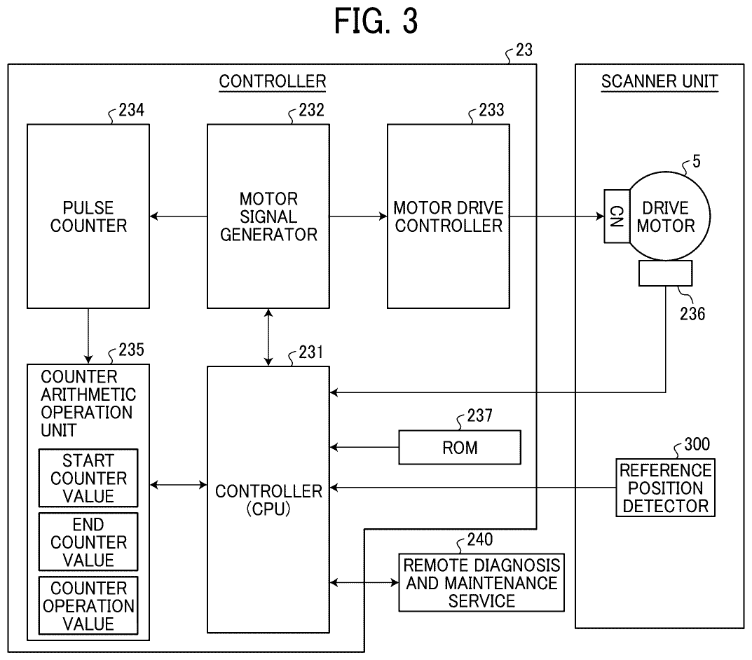

A reference position detector 300 (see FIG. 3) is described as a photointerrupter of the origin position sensor 4. However, the image sensor board 10 may read a reference black line 19 marked on the reference white plate 13 in a main scanning direction to determine the position serving as the start point at which the carriage 6 is driven.

The ADF 102 is mounted above the image reader 101. A document feeder (DF) 18 such as the ADF 102 is coupled to the platen 12 via a hinge or the like so as to be openable and closable with respect to the platen 12. The DF 18 includes a document tray serving as a document table on which a bundle of documents including a plurality of documents can be placed. The DF 18 also includes a separating and feeding unit including a document feeding roller that separates documents one by one from the bundle of documents placed on the document tray and automatically feeds the separated document toward a fed document reading glass 17. Another known configuration is a system in which an additional optical sensor is installed in the DF 18 and both sides of a document are read while the document is fed once. In this way, the image reader 101 provides an operation of reading a document.

FIG. 3 is a functional block diagram illustrating functional units of a control device 23 of the image reader 101, which perform an abnormal stop position specification process for the carriage 6.

As illustrated in FIG. 3, the image reader (scanner unit) 101 includes the control device 23 that controls the abnormal stop position specification process for the carriage 6. The control device 23 of the image reader 101 includes a controller 231 (for example, a central processing unit (CPU)), a motor signal generator 232, a motor drive controller 233, a pulse counter 234, a counter arithmetic operation unit 235, and a read only memory (ROM) 237. The motor signal generator 232, the motor drive controller 233, the pulse counter 234, and the counter arithmetic operation unit 235 may each be implemented by a circuit.

The controller 231 controls the motor signal generator 232, the counter arithmetic operation unit 235, an encoder sensor 236, a remote diagnosis and maintenance service 240, and the entire image reader 101. In this example, the drive motor 5 may be implemented by a stepping motor, a direct current (DC) motor, or any other desired motor.

The controller 231 designates all distances by which the carriage 6 is moved in FIG. 2 with the reference position detector 300 serving as a start point. The reference position detector 300 may employ a system of detecting the carriage 6 with the origin position sensor 4 (for example, a photointerrupter) or a system of obtaining position information based on an electrical signal obtained by optically reading the reference black line 19 marked on the reference white plate 13 in the main scanning direction.

A valid state and an invalid state of the reference position detector 300 are described. In the case of the origin position sensor 4 (for example, the photointerrupter), a state in which the origin position sensor 4 is shielded from light is defined as valid, and the other states are defined as invalid. In the system of optically reading the reference black line 19 marked on the reference white plate 13 in the main scanning direction, a case where the reference black line 19 marked on the reference white plate 13 in the main scanning direction is read while the image reader 101 moves from a position indicated by reference sign 20 to a position indicated by reference sign 14 in the sub-scanning direction or while the image reader 101 moves from the position indicated by reference sign 14 to the position indicated by reference sign 20 is defined as valid. That is, the reference position detector 300 is an example of a reference position detector that detects passage (validity) and non-passage of the carriage 6 through a reference position (for example, the origin position sensor 4 or the reference black line 19).

The motor signal generator 232 outputs a motor pulse and a drive pulse generated in the motor signal generator 232 based on inputs from the controller 231 and the encoder sensor 236, and a forward/reverse rotation signal of the drive motor 5 serving as a driver that drives the carriage 6 to the motor drive controller 233 and to the pulse counter 234. The motor signal generator 232 can vary the width of the pulse to vary the moving speed of the carriage 6. The motor drive controller 233 and the drive motor 5 are an example of a scanning driver that moves the carriage 6 with the drive motor 5 (an example of a motor).

Next, an abnormal stop position specification process for the carriage 6 is described.

While the carriage 6 is driven, when the carriage 6 has not passed through the reference position detector 300 at a predetermined pulse count or when the carriage 6 has passed through the reference position detector 300 earlier than the predetermined pulse count, the controller 231 determines that the stop position of the carriage 6 is abnormal, quickly stops the carriage 6, and notifies a user of an error. That is, the controller 231 functions as an example of an abnormality detector that detects the presence or absence of an abnormality of the stop position of the carriage 6 based on a detection result of passage and non-passage of the carriage 6 through the reference position.

The abnormal stop position specification process for the carriage 6 is performed after the carriage 6 is stopped when an abnormality of the stop position of the carriage 6 has been detected. The pulse counter 234 is reset at the time at which the carriage 6 has stopped. Any value may be used to reset the pulse counter 234.

After the pulse counter 234 is reset, the carriage 6 is moved in a direction toward the reference black line 19 or the origin position sensor 4.

When the origin position sensor 4 has detected the carriage 6 or when the reference black line 19 has been optically read, the reference position detector 300 immediately stops the motor and holds the pulse count value at that time.

The controller 231 causes the counter arithmetic operation unit 235 to arithmetically operate the pulse count value, which is held based on the mechanical layout dimension value of the reference black line 19 or the origin position sensor 4 serving as the start point of driving of the carriage 6, through conversion into a distance, to quantitatively specify the position at which the carriage 6 has stopped, stores the value as a counter operation value, and then notifies the remote diagnosis and maintenance service 240 of the counter operation value.

The remote diagnosis and maintenance service 240 is a server that grasps the states of a MFP and a printer on a network in real time. For example, the remote diagnosis and maintenance service 240 provides accurate and speedy support and service for a customer who has made a maintenance contract. With this configuration, a breakdown of an apparatus or device can be prevented in advance, and even when a malfunction occurs, downtime can be minimized by quick response. Further, periodic replacement of a component, running out of toner, and the like can be predicted in advance. In this example, the control device 23 communicates with the remote diagnosis and maintenance server through a network interface, which is provided for the image reading device.

When an abnormality of the stop position of the carriage 6 has been detected, the controller 231 functions as an example of an abnormal stop position specification unit that specifies a location at which the carriage 6 has abnormally stopped. Accordingly, the location at which the carriage 6 has abnormally stopped can be specified, and hence machine analysis with low reproducibility of a malfunction in the image reading device (scanner) can be reduced for a malfunction of the traveling body drive system that occurs in the market of image reading devices.

Conventionally, when a carriage has abnormally stopped for some reason, there has not been performed abnormality analysis to determine at which point driving of the carriage has failed based on a reference position detector, as a start point, that is provided at a predetermined position and detects passage or non-passage of the carriage.

Hence, in the case of a malfunction symptom other than an obvious defect of a component (for example, detachment of each harness, detachment of a drive belt, or a defect of a drive motor), in a machine (image reading device) in which the malfunction symptom is not frequently reproduced, it is difficult to analyze the malfunction symptom. That is, when it is not possible to acquire information other than information indicating that the stop position of the carriage with a malfunction of the traveling body drive system is valid or invalid with respect to the reference position detector, a machine (image reading device) or the like having low reproducibility of a malfunction may perform defective analysis.

The controller 231 may move the carriage 6 in the sub-scanning direction by a predetermined movement distance after the carriage 6 stops at the time at which an abnormality of the stop position of the carriage 6 has been detected, and may move the carriage 6 by the predetermined movement distance in a direction opposite to the sub-scanning direction after the carriage 6 stops even though passage and non-passage of the carriage 6 through the reference position cannot be detected. Accordingly, the determination on the reference position can be made even with a configuration without the origin position sensor 4 (a configuration in which the determination is made with the reference black line 19).

The controller 231 also functions as an example of a notification unit that holds the pulse count value when passage of the carriage 6 through the reference position could be detected during the abnormal stop position specification process to specify the location at which the carriage 6 has abnormally stopped, and provides a notification of a result indicating that the location at which the carriage 6 has abnormally stopped cannot be specified when passage of the carriage 6 through the reference position cannot be detected. By calculating the location at which the carriage 6 has stopped based on the start point of driving of the carriage 6, a position (the location at which the carriage 6 has abnormally stopped) can be specified with high accuracy with respect to the mechanical layout.

Alternatively or additionally, a notification of a result that the location at which the carriage 6 has abnormally stopped cannot be specified can be provided.

The controller 231 may specify the location at which the carriage 6 has abnormally stopped when a movement failure of the carriage 6 occurs in an operation of adjusting the reference position of the carriage 6 that is executed after the power of the image reading device is on. Accordingly, a defective stop position in the case of a movement error of the carriage 6 that occurs during the operation of adjusting the reference position of the carriage 6 can be specified.

The controller 231 may specify the location at which the carriage 6 has abnormally stopped when a movement failure of the carriage 6 occurs during an initial optical adjustment operation that is executed after the operation of adjusting the reference position of the carriage 6. Accordingly, a defective stop position in the case of a movement error of the carriage 6 that occurs during adjustment of the gain in the initial optical adjustment operation can be specified.

The controller 231 may specify the location at which the carriage 6 has abnormally stopped when a movement failure of the carriage 6 occurs during reading of a flatbed document (FB). The flatbed document is a document used for copying or scanning for the purpose of duplication, and is placed on the platen 12 in FIG. 2. Accordingly, a defective stop position in the case of a movement error of the carriage 6 that occurs when the FB is read can be specified.

The controller 231 may specify the location at which the carriage 6 has abnormally stopped when a movement failure of the carriage 6 occurs during acquisition of white data that is executed before a DF document is read. Accordingly, a defective stop position in the case of a movement error of the carriage 6 that occurs before the DF document is read (during white data acquisition operation) can be specified.

In a case where the controller 231 is connected in a wired or wireless manner to the remote diagnosis and maintenance service 240 that manages the machine state of the image reading device, the controller 231 may function as an example of a transmission unit that notifies the remote diagnosis and maintenance service 240 of the location at which the carriage 6 has abnormally stopped in response to that the controller 231 specifies the location at which the carriage 6 has abnormally stopped. Accordingly, the remote diagnosis and maintenance service 240 can remotely collect the position at which the carriage 6 has abnormally stopped.

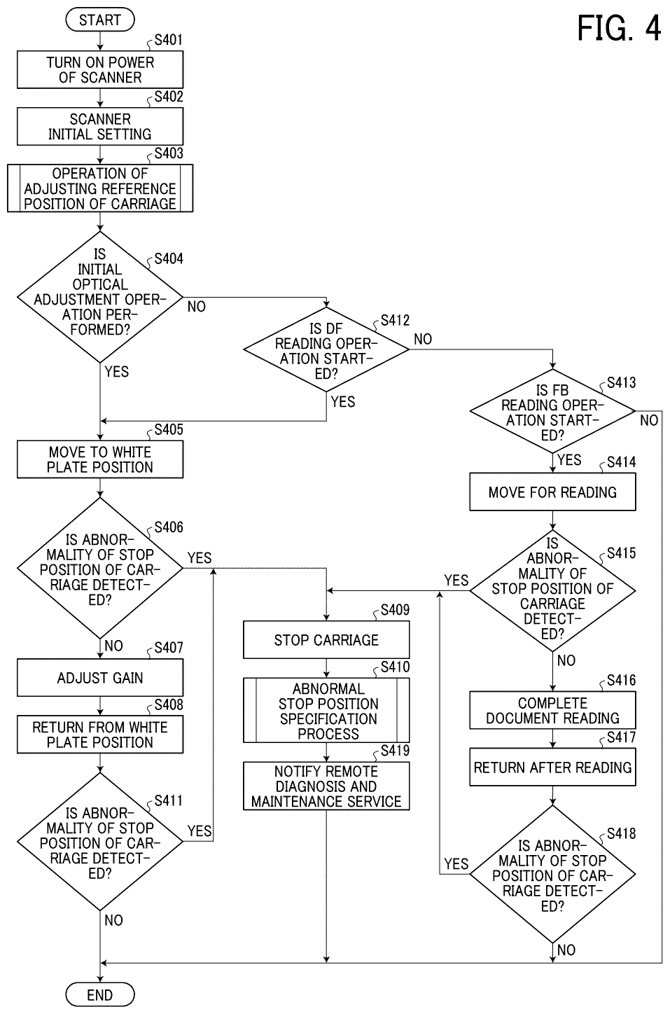

Next, an example flow of a process of detecting an abnormality in movement of the carriage 6 is described with reference to FIG. 4. FIG. 4 is a flowchart presenting the example flow of the process of detecting an abnormality in movement of the carriage 6 in the image reading device according to the embodiment.

After the power of the scanner is turned on (step S401) or in response to recovery from an energy saving state, the controller 231 performs initial setting of each registration (step S402). After the initial setting of each registration, when the reference position of the carriage 6 is adjusted (step S403) and then the initial optical adjustment operation is performed (step S404: Yes), the controller 231 moves the carriage 6 to the reference white plate 13 (white plate position) (step S405). The controller 231 executes a process of detecting an abnormality of the stop position of the carriage 6 (step S406). When an abnormality of the stop position of the carriage 6 has not been detected (step S406: No), the controller 231 adjusts the gain (step S407). After the gain is adjusted, the controller 231 returns the carriage 6 to the position before the movement (white plate position) (step S408).

When an abnormality of the stop position of the carriage 6 has been detected before the carriage 6 moves to the reference white plate 13 in the operation in step S406 (step S406: Yes), the controller 231 stops the carriage 6 (step S409) and performs the abnormal stop position specification process for the carriage 6 (step S410). Then, after storing the counter operation value, the controller 231 notifies the remote diagnosis and maintenance service 240 of the location at which the carriage 6 has abnormally stopped (step S419).

When an abnormality of the stop position of the carriage 6 has been detected during return from the reference white plate 13 in the operation in step S408 (step S411: Yes), the controller 231 stops the carriage 6 (step S409) and performs the abnormal stop position specification process for the carriage 6 (step S410).

After the initial optical adjustment operation in step S404 (step S404: No), the controller 231 enables reading with the DF 18 (step S412). When reading with the DF 18 is performed (step S412: Yes), the controller 231 moves the carriage 6 to the reference white plate 13 before the document starts being read, acquires white data, and returns the carriage 6 to the position before the movement (step S405).

When an abnormality of the stop position of the carriage 6 has been detected before the carriage 6 moves to the reference white plate 13 before the document starts being read (step S406: Yes), the controller 231 stops the carriage 6 (step S409) and performs the abnormal stop position specification process for the carriage 6 (step S410).

When the DF 18 starts the operation of reading the document (step S412: Yes), during return from the reference white plate 13 (step S405), in a case where an abnormality in driving of the carriage 6 has been detected (step S406: Yes), the controller 231 stops the carriage 6 and performs the abnormal stop position specification process for the carriage 6 (steps S409 and S410).

After the initial optical adjustment operation, an operation of reading a flatbed document (FB) can be performed (step S412: No). When the FB is read (step S413: Yes), the controller 231 moves the carriage 6 in the sub-scanning direction to read the document (step S414).

After the document is read, the controller 231 returns the carriage 6 to the position before the movement.

In the operation in step S414, when an abnormality of the stop position of the carriage 6 has been detected before reading of the document is completed (step S415: Yes), the controller 231 stops the carriage 6 (step S409) and performs the abnormal stop position specification process for the carriage 6 (step S410).

When an abnormality of the stop position of the carriage 6 has not been detected in the operation in step S415 (step S415: No), and when the operation of reading the document is completed (step S416), the controller 231 returns the carriage 6 to the position before the movement (step S417). When an abnormality of the stop position of the carriage 6 has been detected before the carriage 6 is returned to the position before the movement in the operation in step S417 (step S418: Yes), the controller 231 stops the carriage 6 (step S409) and performs the abnormal stop position specification process for the carriage 6 (step S410).

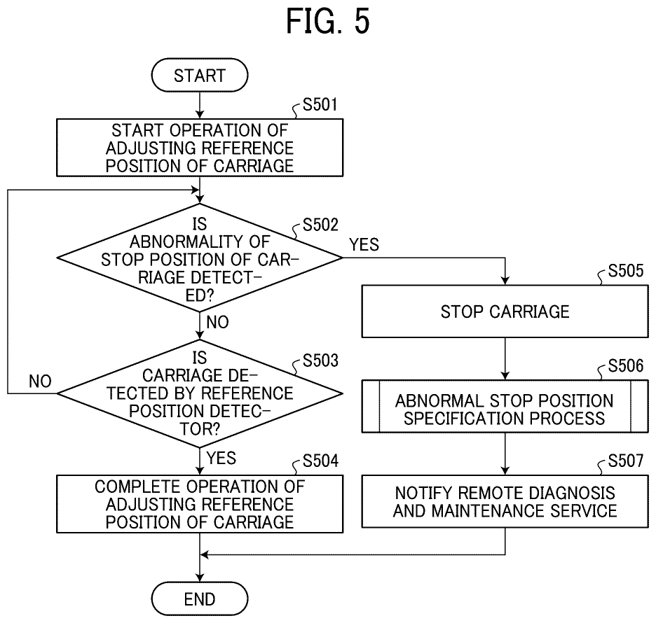

Next, an example flow of the operation of adjusting the reference position of the carriage 6 (the operation presented in step S403 in FIG. 4) is described. FIG. 5 is a flowchart presenting the example flow of the operation of adjusting the reference position of the carriage in the image reading device according to the embodiment.

After the power of the machine (image reader 101) is turned on or in response to recovery from the energy saving state, the controller 231 starts driving the carriage 6 and stops the carriage 6 after the reference position detector 300 is valid to start an operation of determining the initial position of the carriage 6 (the operation of adjusting the reference position of the carriage) (step S501). When an abnormality of the stop position of the carriage 6 has been detected while the carriage 6 is driven or after the carriage 6 is stopped (step S502: Yes), the controller 231 stops the carriage 6 (step S505) and performs the abnormal stop position specification process for the carriage 6 (step S506). Then, after storing the counter operation value, the controller 231 notifies the remote diagnosis and maintenance service 240 of the location at which the carriage 6 has abnormally stopped (step S507).

When an abnormality of the stop position of the carriage 6 has not been detected in step S502 (step S502: No), the controller 231 determines whether the reference position detector 300 has detected the carriage 6 (step S503). When the reference position detector 300 has detected the carriage 6 (step S503: Yes), the controller 231 completes the operation of adjusting the reference position of the carriage (step S504).

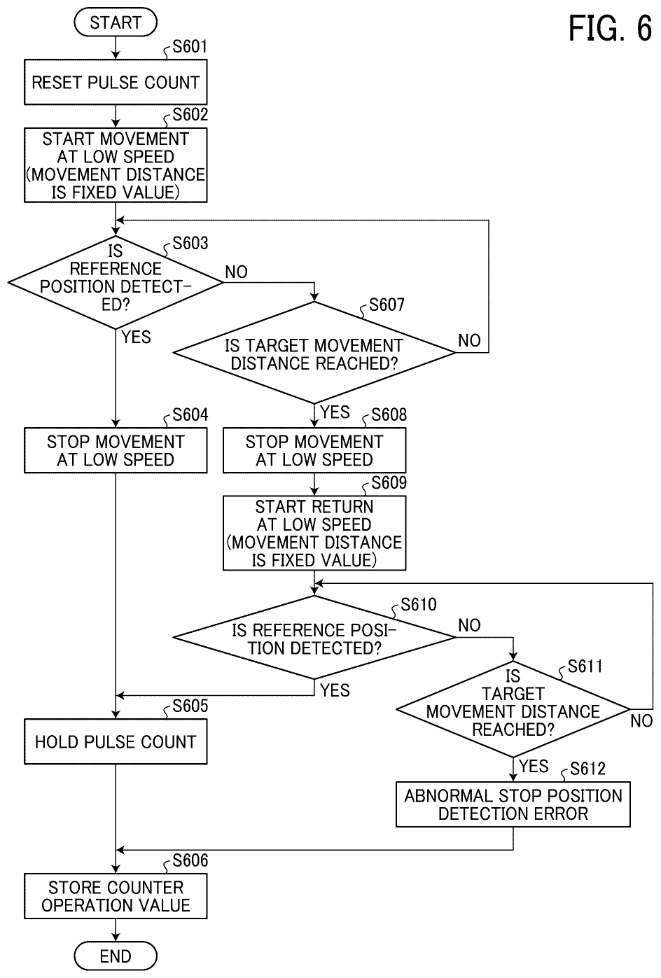

Next, with reference to FIG. 6, an example flow of the abnormal stop position specification process for the carriage 6 in the image reader 101 according to the embodiment is described. FIG. 6 is a flowchart presenting the example flow of the abnormal stop position specification process for the carriage 6 in the image reading device according to the embodiment.

At the time at which the controller 231 has detected an abnormality of the stop position of the carriage 6, the controller 231 resets the pulse counter 234 to a desirable value (step S601). After the count value of the pulse counter 234 is reset, the controller 231 sets a movement distance that the carriage 6 can move in the direction opposite to the sub-scanning direction and by which the carriage 6 can reach the origin position sensor 4 or the reference black line 19 from the maximum movement position indicated by the reference sign 20, and starts moving the carriage 6 in the sub-scanning direction at a low speed (driving in a start/stop region, for example, in the case of driving of a stepping motor) (step S602).

When the origin position sensor 4 has detected the carriage 6 or the reference black line 19 has been optically read (step S603: Yes) before the carriage 6 reaches the movement distance at which the carriage 6 can reach the origin position sensor 4 or the reference black line 19 in the operation in step S602 (the detection method may use any control method such as software polling or hardware interruption), the controller 231 immediately executes a process of stopping the drive motor 5 (step S604), holds the pulse count value at that time (step S605), executes an arithmetic operation process on the counter value, stores, as a counter operation value, the position at which the carriage 6 has stopped with the origin position sensor 4 or the reference black line 19 serving as the start point (step S606), and then notifies the remote diagnosis and maintenance service 240 of the counter operation value.

When the origin position sensor 4 has not detected the carriage 6 or the reference black line 19 has not been optically read (step S603: No) (the detection method may use any control method such as software polling or hardware interruption), that is, when the reference position has not been detected at the time at which the carriage 6 has reached the movement distance at which the carriage 6 can reach the origin position sensor 4 or the reference black line 19 in the operation in step S602, the controller 231 immediately executes the process of stopping the drive motor 5 (step S608) at the time at which the carriage 6 has reached the target movement distance (step S607: Yes), and starts moving the carriage 6 at a low speed (driving in the start/stop region, for example, in the case of driving of the stepping motor) toward the maximum movement position indicated by the reference sign 20 in the direction opposite to the sub-scanning direction while designating a movement distance from the maximum position of the image reader (scanner) 101 in the sub-scanning direction approximately to the origin position sensor 4 or the reference black line 19 (step S609).

When the origin position sensor 4 has detected the carriage 6 or the reference black line 19 has been optically read (step S610: Yes) before the carriage 6 reaches the movement distance at which the carriage 6 can reach the origin position sensor 4 or the reference black line 19 in the operation in step S609 (the detection method may use any control method such as software polling or hardware interruption), that is, when the reference position has not been detected, the controller 231 immediately executes the process of stopping the drive motor 5, holds the pulse count value at that time (step S605), executes the arithmetic operation process on the counter value, stores, as a counter operation value, the position at which the carriage 6 has stopped with the origin position sensor 4 or the reference black line 19 serving as the start point (step S606), and then notifies the remote diagnosis and maintenance service 240 of the counter operation value.

When the carriage 6 has not been detected by the origin position sensor 4 or the reference black line 19 has not been optically read (step S610: No) (the detection method may use any control method such as software polling or hardware interruption) at the time at which the carriage 6 has reached the movement distance at which the carriage 6 can reach the origin position sensor 4 or the reference black line 19 in the operation in step S609 (step S611: Yes), the controller 231 immediately executes the process of stopping the drive motor 5, stores a desirable value in the counter operation value (step S606) as an error of the abnormal stop position specification process (step S612), and then notifies the remote diagnosis and maintenance service 240 of the counter operation value.

As described above, with the image forming apparatus 100 according to the embodiment, the location at which the carriage 6 has abnormally stopped can be specified, and hence machine analysis with low reproducibility of a malfunction in an image reading device such as a scanner can be reduced for a malfunction of the traveling body drive system that occurs in the market of image reading devices.

The program executed by the image forming apparatus 100 according to the embodiment is provided while being incorporated in the ROM 237 or the like in advance. In one example, the program executed by the image forming apparatus 100 according to the embodiment may be stored in a computer-readable storage medium, such as a compact disc read-only memory (CD-ROM), a flexible disk (FD), a compact disc recordable (CD-R), or a digital versatile disk (DVD), in an installable or executable file format, to be provided.

In one example, the program executed by the image forming apparatus 100 according to the embodiment may be stored in a computer connected to a network such as the Internet and downloaded via the network, thus being providable. In one example, the program to be executed by the image forming apparatus according to the embodiment may be provided or distributed via a network such as the Internet.

The program executed by the image forming apparatus 100 according to the embodiment has a module configuration including the above-described units (controller 231). As actual hardware, an example of a processor such as a CPU reads the program from the ROM 237 and executes the program, thereby loading the units onto a main storage device and generating the controller 231 on the main storage device.

While the image forming apparatus according to the disclosure is applied to the MFP having at least two of the copying, printing, scanning, and facsimile functions in the above-described embodiment, the image forming apparatus according to the disclosure may be applied to any one of a copier, a printer, a scanner, and a facsimile apparatus.

A description is given below of some aspects of the present disclosure.

According to Aspect 1, an image reading device that reciprocates a carriage as a traveling body and reads an image of a document includes a scanning driver to move the carriage using a motor; a reference position detector to detect passage and non-passage of the carriage through a reference position; and an abnormality detector to detect an abnormality of a stop position of the carriage based on a detection result of the passage and the non-passage of the carriage through the reference position; and an abnormal stop position specification unit to, in a case where the abnormality of the stop position of the carriage has been detected, specify a location at which the carriage has abnormally stopped.

According to Aspect 2, in the image reading device of Aspect 1, the abnormal stop position specification unit moves the carriage in a sub-scanning direction by a predetermined movement distance after the carriage stops at a time at which the abnormality of the stop position of the carriage has been detected, and moves the carriage by the predetermined movement distance in a direction opposite to the sub-scanning direction after the carriage stops even in a case where the passage and the non-passage of the carriage through the reference position is not detected.

According to Aspect 3, the image reading device of Aspect 1 or Aspect 2 includes a notification unit to, in an abnormal stop position specification process of specifying the location at which the carriage has abnormally stopped, hold a pulse count value in a case where the passage of the carriage through the reference position has been detected, and provide a notification of a result indicating that the location at which the carriage has abnormally stopped is not specified in a case where the passage of the carriage through the reference position is not detected.

According to Aspect 4, in the image reading device of any one of Aspect 1 to Aspect 3, the abnormal stop position specification unit specifies the location at which the carriage has abnormally stopped in response to a movement failure of the carriage that occurs during an operation of adjusting the reference position of the carriage that is executed after power of the image reading device is on.

According to Aspect 5, in the image reading device of any one of Aspect 1 to Aspect 4, the abnormal stop position specification unit specifies the location at which the carriage has abnormally stopped in response to a movement failure of the carriage that occurs during an initial optical adjustment operation that is executed after an operation of adjusting the reference position of the carriage.

According to Aspect 6, in the image reading device of any one of Aspect 1 to Aspect 5, the abnormal stop position specification unit specifies the location at which the carriage has abnormally stopped in response to a movement failure of the carriage that occurs during reading of a flatbed document.

According to Aspect 7, in the image reading device of any one of Aspect 1 to Aspect 6, the abnormal stop position specification unit specifies the location at which the carriage has abnormally stopped in response to a movement failure of the carriage that occurs during acquisition of white data that is executed before a document-feeder document is read.

According to Aspect 8, the image reading device of any one of Aspect 1 to Aspect 7 further includes, in a case where the image reading device is connected in a wired or wireless manner to a remote diagnosis and maintenance service that manages a machine state of the image reading device, a transmission unit to notify the remote diagnosis and maintenance service of the location at which the carriage has abnormally stopped in response to that the location at which the carriage has abnormally stopped is specified.

According to Aspect 9, in the image reading device of any one of Aspect 1 to Aspect 8, the image reading device has at least one of a copying function, a printing function, a scanning function, or a facsimile function.

According to Aspect 10, a method executed by an image reading device that reciprocates a carriage as a traveling body and reads an image of a document includes detecting an abnormality of a stop position of the carriage based on a detection result of passage and non-passage of the carriage through a reference position; and in a case where the abnormality of the stop position of the carriage has been detected, specifying a location at which the carriage has abnormally stopped.

According to Aspect 11, a program that causes a computer that controls an image reading device that reciprocates a carriage as a traveling body and reads an image of a document to function as an abnormality detector to detect an abnormality of a stop position of the carriage based on a detection result of passage and non-passage of the carriage through a reference position; and an abnormal stop position specification unit to, in a case where the abnormality of the stop position of the carriage has been detected, specify a location at which the carriage has abnormally stopped.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image reading device comprising:
a motor to reciprocate a carriage;
a reference position detector to detect passage and non-passage of the carriage through a reference position and output a detection result; and
circuitry configured to, in a case where an abnormality of a stop position of the carriage has been detected based on the detection result, specify a location at which the carriage has abnormally stopped.

2. The image reading device according to claim 1, wherein, based on the detection result indicating that the abnormality of the stop position of the carriage has been detected, the circuitry is configured to:
stop the carriage,
move the carriage by a predetermined movement distance toward one position in a sub-scanning direction, and
move the carriage by the predetermined movement distance toward another position opposite to the one position in the sub-scanning direction.

3. The image reading device according to claim 1, wherein the circuitry is configured to, while specifying the location at which the carriage has abnormally stopped:
hold a pulse count value in a case where the passage of the carriage through the reference position has been detected, and
provide a notification indicating that the location at which the carriage has abnormally stopped is not specified in a case where the passage of the carriage through the reference position is not detected.

4. The image reading device according to claim 1, wherein the circuitry is configured to specify the location at which the carriage has abnormally stopped in response to a movement failure of the carriage that occurs during an operation of adjusting the reference position of the carriage that is executed after power of the image reading device is on.

5. The image reading device according to claim 1, wherein the circuitry is configured to specify the location at which the carriage has abnormally stopped in response to a movement failure of the carriage that occurs during an initial optical adjustment operation that is executed after an operation of adjusting the reference position of the carriage.

6. The image reading device according to claim 1, wherein the circuitry is configured to specify the location at which the carriage has abnormally stopped in response to a movement failure of the carriage that occurs during reading of a flatbed document.

7. The image reading device according to claim 1, wherein the circuitry is configured to specify the location at which the carriage has abnormally stopped in response to a movement failure of the carriage that occurs during acquisition of white data that is executed before a document-feeder document is read.

8. The image reading device according to claim 1, further comprising:
a network interface connected with a remote diagnosis and maintenance service that manages a state of the image reading device via a wired or wireless network,
wherein the circuitry is configured to notify the remote diagnosis and maintenance service of the location at which the carriage has abnormally stopped.

9. The image reading device according to claim 1, wherein the circuitry is configured to execute at least one of a copying process, a printing process, a scanning process, or a facsimile process.

10. A method of reading an image by reciprocating a carriage, the method comprising:
detecting passage and non-passage of the carriage through a reference position to output a detection result; and
in a case where an abnormality of a stop position of the carriage has been detected based on the detection result, specifying a location at which the carriage has abnormally stopped.

11. A non-transitory recording medium storing a plurality of instructions which, when executed by one or more processors, cause the one or more processors to perform a method of reading an image by reciprocating a carriage, the method comprising:
detecting passage and non-passage of the carriage through a reference position to output a detection result; and
in a case where an abnormality of a stop position of the carriage has been detected based on the detection result, specifying a location at which the carriage has abnormally stopped.
